(19) United States
(12) Patent Application Publication
(10) Pub. No.: US 2023/0186879 A1
(43) Pub. Date: Jun. 15, 2023

(54) AUTOMATIC MUSIC PLAYING CONTROL DEVICE, ELECTRONIC MUSICAL INSTRUMENT, METHOD OF PLAYING AUTOMATIC MUSIC PLAYING DEVICE, AND NON-TRANSITORY COMPUTER-READABLE RECORDING MEDIUM

(71) Applicant: CASIO COMPUTER CO., LTD., Tokyo (JP)

(72) Inventors: Jun YOSHINO, Tokyo (JP); Toshiyuki TACHIBANA, Tokyo (JP); Shingo OKANO, Tokyo (JP)

(73) Assignee: CASIO COMPUTER CO., LTD., Tokyo (JP)

(21) Appl. No.: 17/980,789

(22) Filed: Nov. 4, 2022

(30) Foreign Application Priority Data
Dec. 15, 2021 (JP) 2021-203446

(51) Int. Cl. G10H 1/00; G10H 1/36

(52) U.S. Cl. CPC G10H 1/0025; G10H 1/361; G10H 2210/555; G10H 2210/111; G10H 2210/571; G10H 2210/005

(57) ABSTRACT

Provided is an automatic music playing control device that provides an instruction of playing music, the control device implementing natural music playing capable of expressing the timing and voicing in live music playing of a musical instrument by a player. The automatic music playing control device includes at least one processor, and the at least one processor selects a voicing pattern corresponding to a combination of the probabilistically-selected number of sounds to be emitted and a decided voicing type corresponding to a range from among a plurality of voicing patterns based on a scale decided according to the tune and chords of a music piece and instructs a sound source to emit a chord voiced based on the selected voicing pattern.

### CROSS-REFERECE TO RELATED APPLICATION

The present application claims the benefit of priority of Japanese Patent Application No. 2021-203446 filed on Dec. 15, 2021 and all the contents of Japanese Patent Application No. 2021-203446 are incorporated into by reference the specification of the present application.

### BACKGROUND

### 1. Field

The present invention relates to an automatic music playing control device that controls automatic music playing, an electronic musical instrument, a method of playing an automatic music playing device, and a non-transitory computer-readable recording medium.

### 2. Related Art

In the playing of jazz piano parts or guitar parts, the same constituent notes or chords are played at different timing each time in some cases, even if those sounds are played repeatedly. Moreover, it is common in jazz playing to use chords (chord sounds) including tension notes with tension peculiar to jazz, rather than performing voicing (constituent notes) of the chords (chord sounds) of the music piece to be played according to a chord chart.

The tension notes are constituent notes that give tension to the sound of chords and do not interfere with the progression of the chords, out of non-harmonic tones used with major and minor musical harmonies. The tension notes are not uniformly determined by chord types.

In the automatic music playing by an electronic musical instrument, the following conventional techniques are known to achieve automatic music playing by using tension notes of specified chord names and to enable creation of music playing data with a stylish sound (refer to, for example, Japanese Patent Application Laid-Open No. 1998-78779). During automatic music playing, chord data including a set of root note data, type data, and an available note scale data is sequentially specified, and the available note scale data is referenced.

### SUMMARY

According to one aspect of the present invention, there is provided an automatic music playing control device, including at least one processor, wherein the at least one processor: selects a voicing pattern corresponding to a combination of the probabilistically-selected number of sounds to be emitted and a decided voicing type corresponding to a range from among a plurality of voicing patterns based on a scale decided according to the tune and chords of a music piece; and instructs a sound source to emit a chord voiced based on the selected voicing pattern.

According to this disclosure, a voicing pattern is selected on the basis of a combination of the probabilistically-selected number of sounds and a voicing type, and a sound source is instructed to emit a voiced chord, thereby achieving a natural automatic chord accompaniment capable of expressing voicing in live music playing of a musical instrument by a player.

### BRIEF DESCRIPTION OF THE DRAWINGS

FIG. 1 is a diagram illustrating an example of a hardware configuration according to an embodiment of an electronic musical instrument.

FIG. 2 is a flowchart illustrating an example of automatic chord accompaniment processing of an automatic music playing device.

FIG. 3 is a flowchart illustrating a detailed example of timing data generation processing.

FIG. 4A is a diagram illustrating an example of the data structure of a frequency table for timing type selection.

FIG. 4B is a diagram illustrating an example of the data structure of a frequency table for note timing table selection.

FIG. 5A is a diagram illustrating an example of the data structure of Type 2 note timing table 1.

FIG. 5B is a musical notation at the note timing based on Type 2 note timing table 1.

FIG. 5C is a diagram illustrating an example of the data structure of Type 2 note timing table 2.

FIG. 5D is a musical notation at the note timing based on Type 2 note timing table 2.

FIG. 5E is a diagram illustrating an example of the data structure of Type 0 note timing table.

FIG. 5F is a musical notation at the note timing based on Type 0 note timing table.

FIG. 6 is a flowchart illustrating a detailed example of anticipation chord acquisition processing.

FIG. 7 is an explanatory diagram for the anticipation chord acquisition processing.

FIG. 8 is a flowchart illustrating a detailed example of voicing processing.

FIG. 9A is a diagram illustrating example of the data structure for Key C chord progression data.

FIG. 9B is a diagram illustrating examples of the data structures of a scale decision table.

FIG. 9C is a diagram illustrating example of the data structure of a voicing table by scale.

FIG. 10A is a diagram illustrating example of the data structure of a frequency table for poly number selection.

FIG. 10B is a diagram illustrating example of the data structure of a frequency table for voicing table data selection.

FIG. 11A is a musical notation of C7 chord.

FIG. 11B, 11C, 11D, 11E, 11F, 11G, 11H, 11I and 11J are musical notations of voicing variations in C7 chord.

FIG. 12 is a diagram illustrating a connection form according to another embodiment in which the automatic music playing device and the electronic musical instrument operate independently.

FIG. 13 is a diagram illustrating an example of a hardware configuration of an automatic music playing device according to another embodiment in which the automatic music playing device and the electronic musical instrument operate independently.

### DETAILED DESCRIPTION

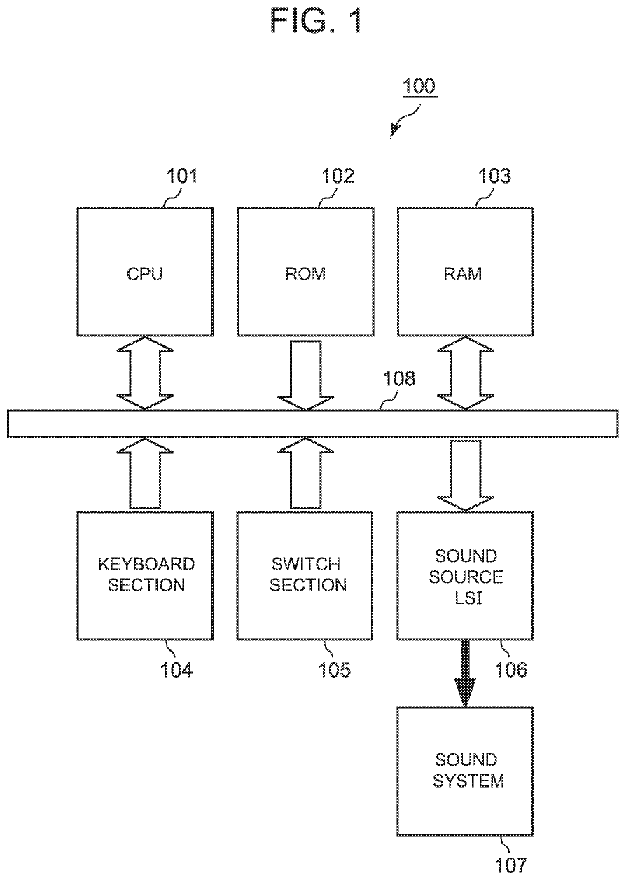

Hereinafter, a mode for carrying out the present disclosure will be described in detail with reference to the drawings. FIG. 1 is a diagram illustrating an example of a hardware configuration according to an embodiment of an electronic keyboard instrument, which is an example of an electronic musical instrument. In FIG. 1, the electronic keyboard instrument 100 is implemented as an electronic piano, for example, and has at least one central processing unit (CPU) 101, a read-only memory (ROM) 102, a random access memory (RAM) 103, a keyboard section 104 including a plurality of white keys and a plurality of black keys as a plurality of music playing operators, a switch section 105, and a sound source LSI 106, all of which are interconnected by a system bus 108. The output of the sound source LSI 106 is input to a sound system 107.

At least one CPU 101 constitutes an automatic music playing control device, together with the ROM 102 and the RAM 103.

This electronic keyboard instrument 100 has a function of an automatic music playing device that performs automatic chord accompaniment of a piano part. Furthermore, the automatic music playing device of the electronic keyboard instrument 100 is able to automatically generate the sound emission data of the automatic piano accompaniment of jazz music, for example, not by simply playing the programmed data, but by using an algorithm within a certain musical rule.

The CPU 101 performs a control operation of the electronic keyboard instrument 100 illustrated in FIG. 1 by loading a control program stored in the ROM 102 into the RAM 103 and executing the control program, while using the RAM 103 as a working memory. In particular, the CPU 101 loads a control program illustrated in a flowchart described later from the ROM 102 to the RAM 103 and executes the control program, thereby performing a control operation for an automatic chord accompaniment of a piano part.

The keyboard section 104 detects the pressing or releasing operations of respective keys as the plurality of music playing operators, and notifies the CPU 101. In addition to the control operation for the automatic chord accompaniment of the piano part described later, the CPU 101 performs processing of generating sound emission instruction data for controlling the sound emission or mute of music sounds corresponding to the keyboard music playing by a player on the basis of the notification of detecting the key-pressing or key-releasing operation notified by the keyboard section 104. The CPU 101 notifies the sound source LSI 106 of the generated sound emission instruction data.

The switch section 105 detects the operations of various switches by the player and notifies the CPU 101.

The sound source LSI 106 is a large-scale integrated circuit for generating music sounds. The sound source LSI 106 generates digital music sound waveform data on the basis of the sound emission instruction data, which is input from the CPU 101, and outputs the digital music sound waveform data to the sound system 107. The sound system 107 converts the digital music sound waveform data, which has been input from the sound source LSI 106, to analog music sound waveform signals, and then amplifies the analog music sound waveform signals with a built-in amplifier to emit sounds from a built-in loudspeaker.

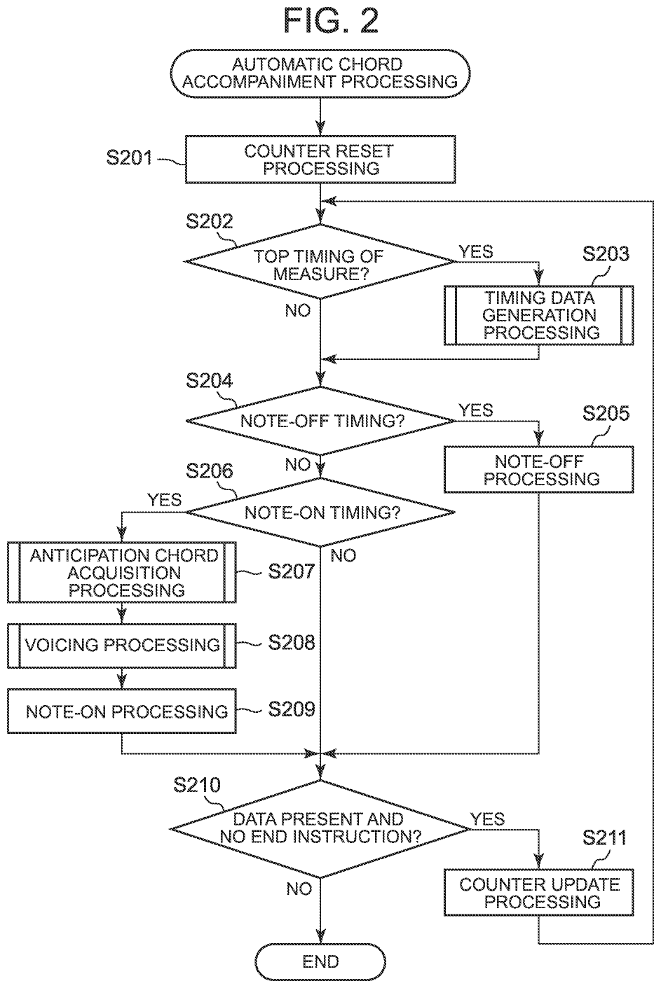

The following describes the details of the automatic chord accompaniment processing of the piano part according to the embodiment of the automatic music playing device of the electronic keyboard instrument 100 having the above configuration (hereinafter, referred to as “present automatic music playing device”). FIG. 2 is a flowchart illustrating an example of the automatic chord accompaniment processing of the present automatic music playing device. This processing is performed by the CPU 101 in FIG. 1 that loads a program for the control processing for the automatic chord accompaniment of the piano part stored in the ROM 102 into the RAM 103.

When the player selects a genre (for example, “jazz”) and tempo of the automatic accompaniment by operating the switch section 105 in FIG. 1 and then presses an automatic accompaniment start switch, which is not particularly illustrated, in the switch section 105, thereupon the CPU 101 starts the automatic chord accompaniment processing illustrated in the flowchart in FIG. 2.

First, the CPU 101 performs counter reset processing (step S201). Specifically, the CPU 101 resets a measure counter variable value stored in the RAM 103, which indicates the number of measures from the start of the automatic chord accompaniment of the piano part, to a value indicating the first measure (for example, “1”) of the automatic chord accompaniment of the piano part. Moreover, the CPU 101 resets a beat counter variable value stored in the RAM 103, which indicates the number of beats (beat position) within the measure, to a value indicating the first beat (for example, “1”). Subsequently, the control of the automatic piano accompaniment by the automatic music playing device proceeds with the value of a tick variable stored in the RAM 103 (the value of this variable is hereinafter referred to as “tick variable value”) as a unit. A TimeDivision constant that indicates the time resolution of the automatic chord accompaniment (the value of this variable is hereinafter referred to as “TimeDivision constant value”) is set in advance in the ROM 102 in FIG. 2, and this TimeDivision constant value indicates the resolution of a quarter note. If this value is 128, for example, the quarter note has a duration of “128×tick variable value.” Note that the actual number of seconds per tick depends on the tempo specified for the piano part of the automatic chord accompaniment. If the value set to the Tempo variable on the RAM 103 according to the user setting is “Tempo variable value [beats/minute],” the number of seconds of one tick (hereinafter, referred to as “tick second value”) is calculated by the following formula (1).

Tick second value=60/Tempo variable value/TimeDivision variable value (1)

Therefore, in the counter reset processing of step S201 in FIG. 2, the CPU 101 first calculates the tick second value by the calculation processing corresponding to the above formula (1), and stores the calculated value in the “tick second variable” on the RAM 103. In the initial state, the Tempo variable value may be initially set to a given value such as, for example, 60 [beats/second], which is read from the constants in the ROM 102 of FIG. 2.

Alternatively, the Tempo variable may be stored in a non-volatile memory, and when the power supply of the electronic keyboard instrument 100 is turned on again, the Tempo variable value at the end of the last time may be retained as it is.

Subsequently, the CPU 101 first resets the tick variable value on the RAM 103 to zero in the counter reset processing of step S201 in FIG. 2. Thereafter, the CPU 101 sets the built-in timer hardware, which is not particularly illustrated, for timer interrupt by the tick second value calculated as described above and stored in the tick second variable on the RAM 103. As a result, an interrupt (hereinafter, referred to as “tick interrupt”) is generated every time the number of seconds of the above tick second value elapsed in the timer.

When the player changes the tempo of the automatic chord accompaniment by operating the switch section 105 in FIG. 1 in the middle of the automatic chord accompaniment of the piano part, the CPU 101 calculates the tick second value, in the same manner as in the counter reset processing in step S201, by performing the calculation processing corresponding to the above formula (1) again by using the Tempo variable value that has been reset to the Tempo variable value on the RAM 103. Thereafter, the CPU 101 sets up a timer interrupt based on the newly calculated tick second value for the built-in timer hardware. As a result, a tick interrupt occurs every time the number of seconds of the tick second value newly set in the timer elapses.

After the counter reset processing in step S201, the CPU 101 repeats the series of processes of steps S202 to S211 as loop processing. This loop processing is repeated until it is determined in step S210 that the automatic chord accompaniment data is no longer available or that the player has given an instruction to end the automatic piano accompaniment by means of a switch, which is not particularly illustrated, in the switch section 105 in FIG. 1.

In the case where a new tick interrupt request is generated by the timer in the counter update processing of step S211 in the above loop processing, the CPU 101 counts the tick counter variable value on the RAM 103 by the tick interrupt processing. Thereafter, the CPU 101 releases the tick interrupt. If no tick interrupt request is generated, the CPU 101 does not count the tick counter variable value by the tick interrupt processing, and ends the counter update processing of step S211 directly. As a result, the tick counter variable value is counted every second of the tick second value calculated so as to correspond to the Tempo variable value set by the player.

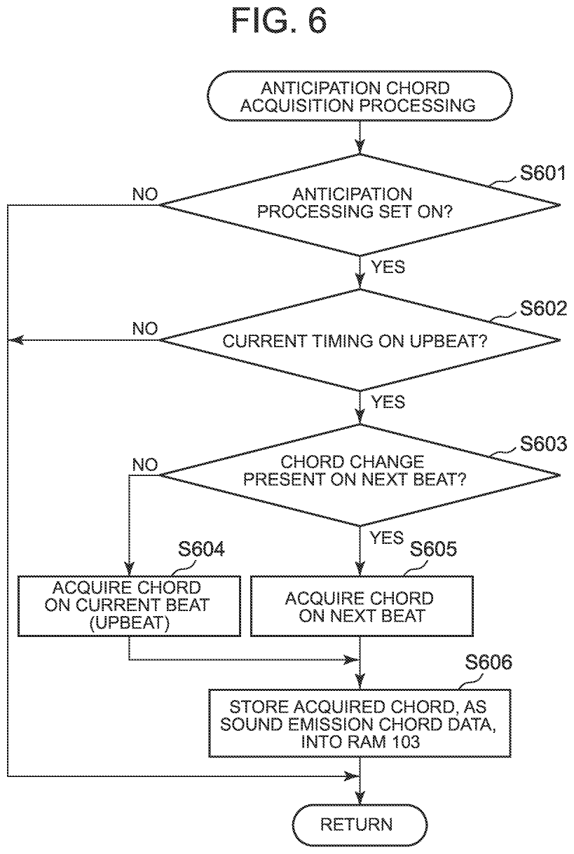

The CPU 101 controls the progression of the automatic chord accompaniment with reference to the above tick counter variable value that is counted every second of the tick second value in step S211. Hereinafter, the unit of time synchronized with the tempo, whose unit is the tick counter variable value=1, is denoted as [tick]. As mentioned above, if the TimeDivision constant value, which indicates the resolution of a quarter note, is, for example, 128, then the quarter note has a duration of 128 [ticks]. Therefore, if the piano part to which the automatic chord accompaniment is applied has, for example, four beats per measure, one beat=128 [ticks], and 1 measure=128 [ticks]×4 beats=512 [ticks]. In the counter update processing of step S211 of the above loop processing, for example, if a piano part with four beats per measure is selected, the CPU 101 updates the beat counter variable value stored in the RAM 103 from 1→2→3→4→1→2→3 and so on, looping between 1 and 4, every time the tick counter variable value is updated to a multiple of 128. In addition, the CPU 101 resets the intra-beat tick counter variable value for counting the tick time from the beginning of each beat to 0 at the timing when the above beat counter variable value is changed in the counter update processing in step S211. Furthermore, in the counter update processing of step S211, the CPU 101 counts the measure counter variable value stored in the RAM 103 by +1 at the timing when the above beat counter variable value changes from 4 to 1. This measure counter variable value represents the number of measures from the beginning of the automatic chord accompaniment of the piano part, and the beat counter variable value represents the number of beats (beat position) in each measure represented by the measure counter variable value. If the value of the intra-beat tick counter variable value is between 0 and 63 (=128+2−1), the value indicates the timing of a downbeat, and if the value is between 64 and 127, the value indicates the timing of an upbeat. These values are determined in step S602 of the anticipation chord acquisition processing as illustrated in the flowchart in FIG. 6 described later.

The CPU 101 repeats the above step S211 as loop processing to update the tick counter variable value, the intra-beat tick counter variable value, the beat counter variable value, and the measure counter variable value, while performing a series of control processes of steps S202 to S210 described below.

The following describes the details of the series of control processes of steps S202 to S210 in FIG. 2. First, the CPU 101 determines whether the current timing is the top timing of a measure (step S202). Specifically, the CPU 101 determines whether the measure counter variable value stored in the RAM 103 has changed (increased by 1) between the last execution of step S202 and the current execution.

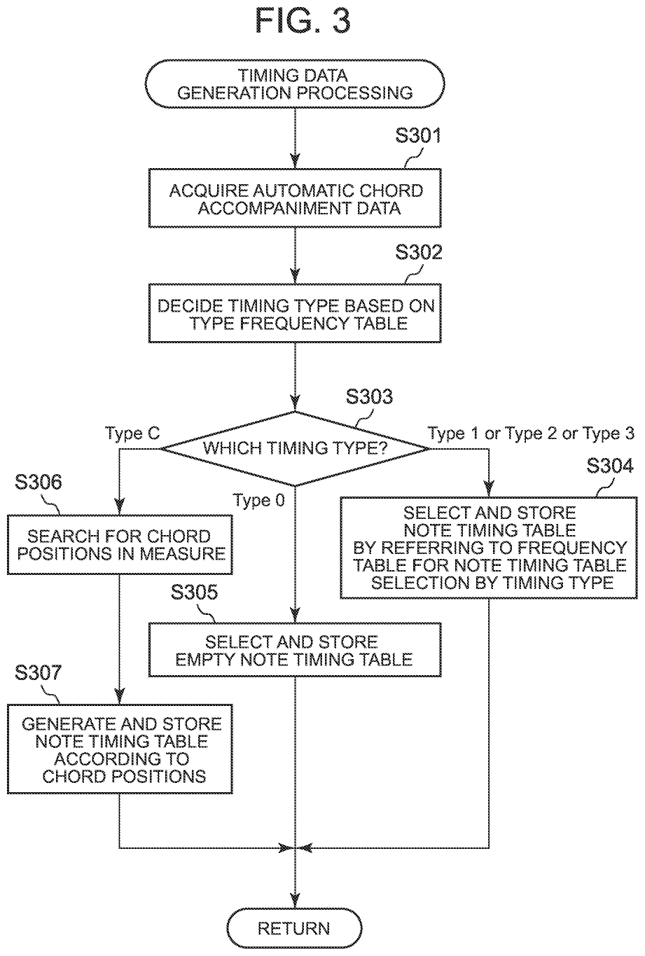

When the determination of step S202 is YES, the CPU 101 performs timing data generation processing (step S203). In this processing, the CPU 101 generates note timing table data that indicates the sound emission timings of new one-measure chords indicated by the updated measure counter variable value, and stores the note timing table data into the RAM 103. Moreover, the CPU 101 reads each new one-measure automatic chord accompaniment data indicated by the updated measure counter variable value corresponding to each sound emission timing in the generated note timing data, for example, from the ROM 102 to the RAM 103. The automatic chord accompaniment data includes, for example, at least a chord and a key. The details of this processing are described later with reference to the flowchart in FIG. 3. When the determination of step S202 is NO, the CPU 101 skips the timing data generation processing in step S203, without performing it.

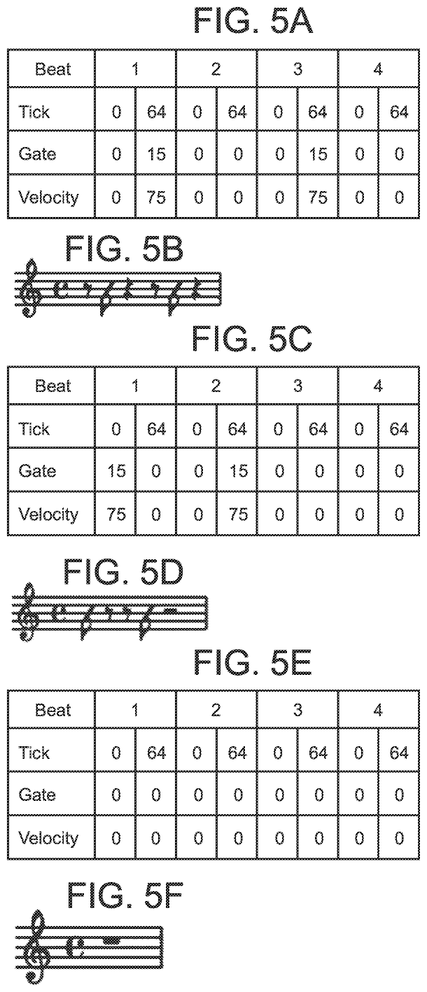

Subsequently, the CPU 101 determines whether the current timing is note-off timing (step S204). Specifically, the CPU 101 determines whether the current beat counter variable value and the intra-beat tick counter variable value stored in the RAM 103 match the beat number and the [tick] time of the chord mute timing of any of the note timing data stored in the RAM 103 in step S203. The beat number of any chord mute timing in this case is any “beat” item value that contains a timing with a non-zero “Gate” item value set in the note timing data illustrated in FIG. 5C or FIG. 5E described later. Moreover, the [tick] time of any of the above chord mute timing is the [tick] time value that is obtained by adding the “Tick” item value of the timing, for which the non-zero “Gate” item value is set, and the “Gate” item value concerned.

When the determination in step S204 is YES, the CPU 101 performs the note-off processing (step S205). Specifically, the CPU 101 instructs the sound source LSI 508 to mute the voice group indicated by the voicing table data stored in the RAM 103 in the voicing processing of step S208 described later, corresponding to the timing determined in step S204.

When the determination in step S204 is NO, the CPU 101 determines whether the current timing is a note-on timing (step S206). Specifically, the CPU 101 determines whether the current beat counter variable value and intra-beat tick counter variable value stored in the RAM 103 match the beat number and [tick] time of any chord emission timing in the note timing table stored in the RAM 103 in step S203. The beat number of any chord emission timing in this case is any “beat” item value that contains a timing with a non-zero “Gate” item value set in the note timing table illustrated in FIG. 5A or FIG. 5C described later.

In addition, the [tick] time of any chord emission timing described above is the “tick” item value of the timing with the non-zero “Gate” item value set.

When the determination in step S206 is YES, the CPU 101 performs anticipation chord acquisition processing (step S207). The details of this processing are described later with reference to the flowchart illustrated in FIG. 6.

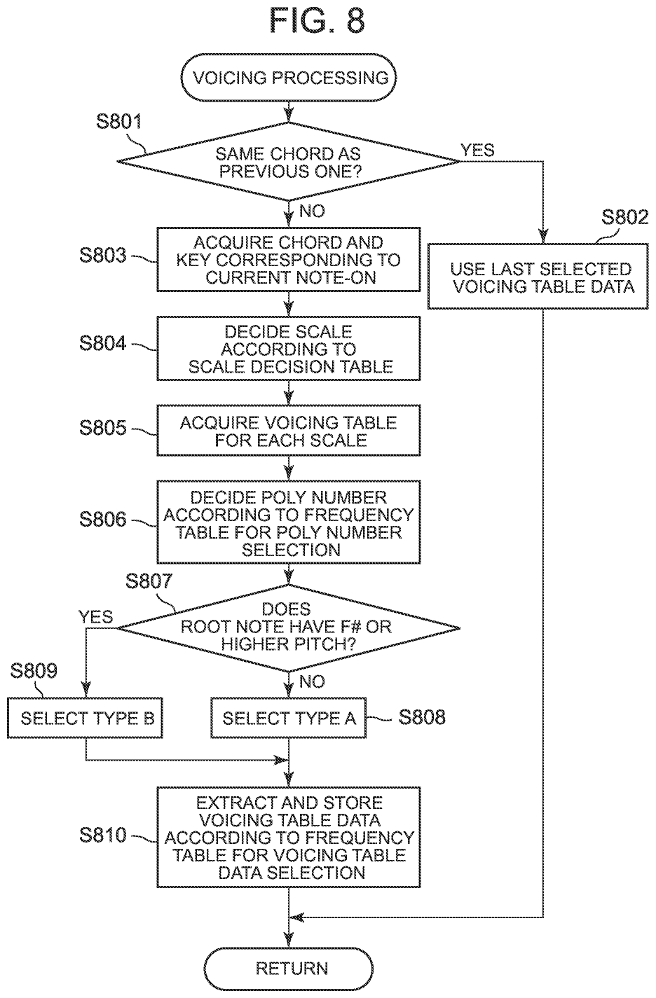

Subsequently, the CPU 101 performs voicing processing (step S208). In this processing, the CPU 101 decides the voicing table data for the chord and key corresponding to the current note-on extracted from the automatic chord accompaniment data of the current measure stored in the RAM 103, and stores the voicing table data in the note-on area of the RAM 103. The automatic chord accompaniment data of the current measure stored in the RAM 103 is read in the timing data generation processing of step S203, which is described in detail later. The details of the voicing processing in step S208 are described later with reference to the flowchart illustrated in FIG. 8. After the processing of step S208, the CPU 101 performs the note-on processing (step S209). In this processing, the CPU 101 instructs the sound source LSI 508 to emit a sound at an anticipation timing in step S207 and to emit sounds of the music sounds of the note number corresponding to each voice of the voice group indicated by the voicing table data stored in the RAM 103 in the voicing processing of step S208. The velocity specified for the sound source LSI 508 along with each note number is a

“Velocity” item value stored in the note timing data of the current measure, corresponding to the note-on timing determined in step S206. The CPU 101 that performs the processing of step S209 operates as a sound emission instruction unit.

When the determination in step S206 is NO, or after the end of the processing in step S209, the CPU 101 determines whether there is still automatic chord accompaniment data to be read from the ROM 102 or the like, and whether the player has not given an instruction to terminate the automatic piano accompaniment by a switch, which is not particularly illustrated, in the switch section 105 of FIG. 1 (step S210).

When the determination in step S210 is YES, the CPU 101 performs the above counter update processing in step

S211, and then returns to the processing of step S202 to continue the loop processing. When the determination in step S210 is NO, the CPU 101 terminates the automatic chord accompaniment processing illustrated in the flowchart of FIG. 2.

FIG. 3 is a flowchart illustrating a detailed example of timing data generation processing in step S203 of FIG. 2. In this processing, the CPU 101 decides the note timing and the gate time for emitting sounds within the newly-updated current measure for each timing at the beginning of the measure determined in step S202. In this case, the CPU 101 probabilistically decides the number of chord emissions (timing type) within the measure concerned and the note timing table that specifies at what timing each chord is to be emitted.

In the flowchart illustrated in FIG. 3, the CPU 101 first acquires one-measure automatic chord accompaniment data of the measure corresponding to the newly-updated measure counter variable value in the RAM 103, for example, from the ROM 102, and then stores the automatic chord accompaniment data in the RAM 103 (step S301). The one-measure automatic chord accompaniment data contains, for example, zero or more sets of data, each set of which contains at least a chord. When there is no chord to be emitted in the measure, the number of data sets is zero. The player is able to pre-select a music piece for the automatic chord accompaniment data by the selection switch, which is not particularly illustrated, in the switch section 105 in FIG. 1. Thereby, the key of the music piece of the automatic chord accompaniment data and the tempo range described later are decided.

Subsequently, the CPU 101 probabilistically decides the timing type by referring to, for example, the frequency table for timing type selection stored in the ROM 102 in FIG. 1 (step S302). The timing type is data that specifies the number of chord emissions in one measure. Specifically, in step S302, the number of chord emissions in the current measure is probabilistically decided.

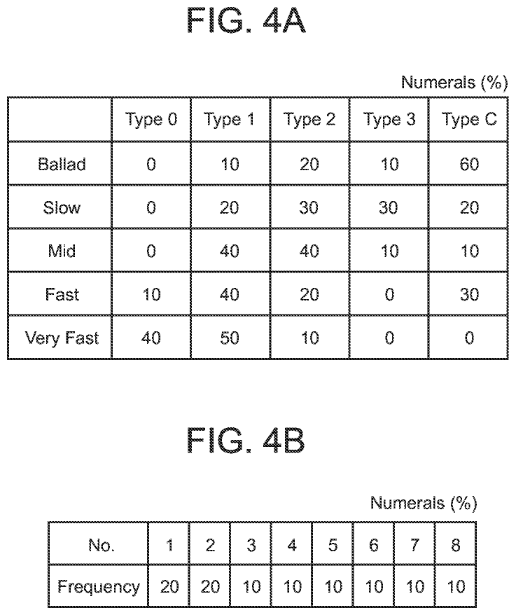

FIG. 4A is a diagram illustrating an example of the data structure of a frequency table for timing type selection stored in the ROM 102 in FIG. 1 to implement the process of step S302. The terms “Type 0,” “Type 1,” “Type 2,” “Type 3,” and “Type C” illustrated in FIG. 4A represent timing types having the following meanings. In FIG. 4A and the following description, “timing type” is sometimes abbreviated as “Type.”
Type 0: Give an instruction to emit a chord 0 times in one measure.
Type 1: Give an instruction to emit a chord once in one measure.
Type 2: Give an instruction to emit a chord twice in one measure.
Type 3: Give an instruction to emit a chord three times in one measure.

Type C: Give an instruction to emit a chord at the beginning and at each chord change in one measure.

The terms “Ballad,” “Slow,” “Mid,” “Fast,” and “Very Fast” in the leftmost column of the frequency table for timing type selection illustrated in FIG. 4A represent the tempo ranges of the automatic chord accompaniment data. When the player selects desired one of provided multiple automatic chord accompaniment music pieces at the start of the automatic chord accompaniment by means of a selection switch, which is not particularly illustrated, in the switch section 105 in FIG. 1, the selected automatic chord accompaniment data has preset one of the tempo ranges of the above “Ballad,” “Slow,” “Mid,” “Fast,” and “Very Fast.” In this respect, “Ballad” corresponds to a tempo range of less than 70, for example. The term “Slow” corresponds to a tempo range of 70 or more and less than 100, for example. The term “Mid” corresponds to a tempo range of 100 or more and less than 150, for example. The term “Fast” corresponds to a tempo range of 150 or more and less than 250, for example. Furthermore, the term “Very Fast” corresponds to a tempo range of 250 or more, for example.

In step S302 of FIG. 3, the CPU 101 performs the following control processing by using the frequency table for timing type selection, which is illustrated in FIG. 4A and stored in the ROM 102. First, in the case where the automatic chord accompaniment data read from the ROM 102 in step S301 of FIG. 3 has, for example, the tempo range “Ballad” set therein, the CPU 101 refers to the data of the row in which “Ballad” is registered in the left-most item in the frequency table for timing type selection illustrated in FIG. 4A. In this row, there are settings of frequency values that indicate that the above timing types, namely Type 0, Type 1, Type 2, Type 3, and Type C are selected with a probability of 0%, 10%, 20%, 10%, and 60%, respectively. On the other hand, the CPU 101 generates an arbitrary random number value with a value range of 1 to 100, for example. Then, the CPU 101 selects the timing type “Type 1,” for example, if the generated random number value is in the random number range of 1 to 10 (corresponding to the frequency value of 10% for “Type1”). Alternatively, the CPU 101 selects the timing type “Type 2,” for example, if the generated random number value is in the random number range of 11 to 30 (corresponding to the frequency value of 20% for “Type 2”). Alternatively, the CPU 101 selects the timing type “Type 3,” for example, if the generated random number value is in the random number range of 31 to 40 (corresponding to the frequency value of 10% for “Type 3”). Alternatively, the CPU 101 selects the timing type “Type C,” for example, if the generated random number value is in the random number range of 41 to 100 (corresponding to the frequency value of 60% for “Type C”). Note that “Type 0” is not selected because the frequency value thereof is 0% in the example illustrated in FIG. 4A and therefore the random number range is not set therefor. Naturally, a random number range may be set for “Type 0” so that it is selected with a certain probability (frequency value). In this way, the CPU 101 is able to select the “Type 0,” “Type 1,” “Type 2,” “Type 3,” and “Type C” timing types with the probability of 0%, 10%, 20%, 10%, and 60% set in the “Ballad” row of the frequency table for timing type selection, respectively.

Also, in the case where, for example, the tempo range “Slow,” “Mid,” “Fast,” or “Very Fast” is set in the automatic chord accompaniment data read from the ROM 102 in step S301 in FIG. 3, the CPU 101 refers to each frequency value in one of the rows in which “Slow,” “Mid,” “Fast,” and “Very Fast” are respectively registered in the leftmost item in the frequency table for timing type selection having the configuration illustrated in FIG. 4A, for example, in the same manner as in the above case in which “Ballad” is set. Subsequently, the CPU 101 sets each random number range of 1 to 100 according to the frequency value [%] set for each timing type of “Type 0,” “Type 1,” “Type 2,” “Type 3,” or “Type C” in the row. Then, the CPU 101 generates a random number value in the range of 1 to 100, and selects one of the timing types of “Type 0,” “Type 1,” “Type 2,” “Type 3,” and “Type C” according to which range the generated random number value falls within among the above random number ranges. In this way, the CPU 101 is able to select each of the “Type 0,” “Type 1,” “Type 2,” “Type 3,” and “Type C” timing types with the probability corresponding to each frequency value set in each tempo range row in the frequency table for timing type selection.

In an automatic chord accompaniment with a slow tempo such as “Ballad,” the sound emission in a measure is often performed chord by chord, and therefore the frequency value (probability) of selecting “Type C” is large, for example, like 60% as illustrated in FIG. 4A.

The contents of the chord accompaniment of music are greatly affected by the tempo. For example, if a piece of music with a fast tempo contains chords with many sound emissions (many note timings), it will be played in a hurry and deviate from a natural music playing, resulting in a very mechanical music playing. At the same time, even for a music piece with a slow tempo, music playing with many sound emissions would be unnatural. On the other hand, it is not good to decide the occurrence probability of each timing type in a uniform manner, because even within a single music piece, appropriate changes are necessary.

Therefore, in this embodiment, there is used a technique called frequency table, in other words, the frequency table for timing type selection as illustrated in FIG. 4A, thereby enabling an appropriate timing type (the number of chord emissions in one measure) that matches the tempo of the automatic chord accompaniment to be probabilistically selected.

Then, in the flowchart illustrated in FIG. 3, the CPU 101 determines the content of the timing type probabilistically selected in step S302 (step S303). The

CPU 101 performs step S304 if the timing type is “Type 1,” “Type 2,” or “Type 3,” performs step S305 if the timing type is “Type 0,” and performs steps S306 and S307 if the timing type is “Type C.”

When the result of the determination in step S303 is that the timing type is one of “Type 1,” “Type 2,” and “Type 3,” that is, the number of chord emissions in the measure is one, two, or three, the CPU 101 probabilistically selects one of, for example, the plurality of note timing tables stored in the ROM 102 for each timing type in step S304, and stores the selected note timing table into the RAM 103. In this way, in this embodiment, for each probabilistically selected timing type (the number of chord emissions in the measure), one note timing table is able to be further probabilistically selected from among a plurality of variations.

FIGS. 5A and 5C illustrate examples of the data structure of the note timing tables 1 and 2, which are prepared in multiple (for example, eight examples) for the timing type “Type 2,” for example. As illustrated in these examples, a note timing table contains the settings of the information as described below for each of the sound emission timings in the eight horizontal columns, which are made of, for example, one to four beats of one measure and each thereof divided into half beats. Note that this example is for a case where the automatic chord accompaniment is played at four beats per measure, and in the case where the automatic chord accompaniment is played at other beats per measure, the sound emission timing is delimited on the basis of the number of beats corresponding to the number of beats per measure.

First, for each head timing in the above half-beat units in the row with a character string “Tick” set in the leftmost column in FIG. 5A or 5C (hereinafter, this row is referred to as “Tick row”), the [tick] time from the beginning of the beat that contains the timing to the beginning of the timing is set. As these values, 0 [tick] is set at the head timing of the half beat of the first half (hereinafter, referred to as “downbeat”) of each of the first, second, third, and fourth beats, because of the beginning of each beat. In addition, 64 [ticks] is set at the head timing of the half beat of the second half (hereinafter, referred to as “upbeat”) of each of the first, second, third, and fourth beats, since the timing is exactly at just a half of each beat (=128 [ticks]). FIG. 5A or 5C illustrates an example in the case where one beat is 128 [ticks].

Subsequently, in the case where the timing is the chord emission timing, a value expressed by a [tick] time as a length of a chord to be emitted there is set for each of the head timings in the above half-beat units in the row with a character string “Gate” set in the leftmost column in FIG. 5A or 5C (hereinafter, this row is referred to as “Gate row”). In the “Type 2 note timing table 1” illustrated in FIG. 5A, a chord length=15 [ticks] is set at two timings for the upbeat of the first beat and for the upbeat of the third beat in the Gate row. On the other hand, in the “Type 2 note timing table 2” illustrated in FIG. 5C, a chord length=15 [ticks] is set in the Gate row at two timings for the downbeat of the first beat and for the upbeat of the second beat.

Furthermore, for each of the head timings in the above half-beat units in the row with a character string “Velocity” set in the leftmost column in FIG. 5A or 5C (hereafter, this row is referred to as “Velocity row”), in the case where the timing is the chord emission timing, the velocity value (the maximum value is 127) is set for each voice constituting the chord to be emitted there. In the “Type 2 note timing table 1” illustrated in FIG. 5A, the velocity value=75 is set at two timings for the upbeat of the first beat and for the upbeat of the third beat in the Velocity row. Similarly, in the “Type 2 note timing table 2” illustrated in FIG. 5C, the velocity value=75 is set in the Velocity row at two timings for the downbeat of the first beat and for the upbeat of the second beat. For the timings at which no sound is emitted, the velocity value=0 is set.

As described above, for example, in the case where “Type 2 note timing table 1” in FIG. 5A is selected in step S303−>step S304 of FIG. 3, one-measure chords are emitted at the sound emission timings illustrated as the musical notation in FIG. 5B. For example, in the case where “Type 2 note timing table 2” in FIG. 5C is selected, one-measure chords are emitted at the sound emission timings illustrated as the musical notation in FIG. 5D, which is different from the musical notation in FIG. 5B, as a result.

As the note timing tables as described above, a plurality of note timing tables may be prepared in the ROM 102 as illustrated in FIGS. 5A and 5C for each of “Type 1,” “Type 2,” and “Type 3.” In this case, the CPU 101 probabilistically selects one of the plurality of note timing tables stored in the ROM 102, corresponding to the timing type decided in step S302, and stores the selected note timing table into the RAM 103.

In order to implement this probabilistic selecting operation, a frequency table for note timing table selection by timing type, which has the data structure as illustrated in FIG. 4B, is stored in the ROM 102 and used. The frequency table may have different settings for each timing type. In the frequency table for note timing table selection by timing type having the data structure illustrated in FIG. 4B, the row with “No.” registered in the leftmost item contains the settings of the numbers of the note timing tables of the timing types that can be selected as illustrated in FIG. 5A or 5C, in order from 1 to 8 in the example of FIG. 4B. In addition, in each column of the row in which “frequency” is registered in the leftmost item, there is set a frequency value [%] at which the note timing table having the number set in the same column is selected. For the frequency table as illustrated in FIG. 4B, the CPU 101 generates an arbitrary random number value with a value range of 1 to 100, for example, as in the case of the frequency table for timing type selection in FIG. 4A. Then, the CPU 101 selects the note timing table 1 if the generated random number value is in the random number range of 1 to 20 (corresponding to a 20% probability of selecting the note timing table with number 1), for example. Alternatively, for example, if the generated random number value is in the random number range of 21 to 40 (corresponding to a 20% probability of selecting the note timing table with the number 2), the CPU 101 selects the note timing table 2. Note timing tables with other numbers are also selected probabilistically as in the case of the note timing table 1 or 2.

As described above, in this embodiment, the frequency table for timing type selection illustrated in FIG. 4A is used, first, in step S302 of FIG. 3 for each measure, thereby enabling probabilistic selection of the number of chord emissions in the measure that matches the tempo of the currently selected automatic chord accompaniment, as the timing type. Then, the frequency data for note timing table selection by timing type illustrated in FIG. 4B is used, secondly, in step S303−>step S304 of FIG. 3 for each measure, thereby enabling probabilistic selection of one of the plurality of note timing tables having chord emission timings different from each other, which are prepared for the respective selected timing types (“Type 1,” “Type 2,” and “Type 3”). Thereby, in this embodiment, the automatic chord accompaniment is able to be performed while probabilistically changing the number of chord emissions and the chord emission timing for each measure. In other words, a player is able to achieve a musical expression also in the automatic chord accompaniment, as the musical expression performed while changing the number of chord emissions in each measure and the chord emission timing in half-beat units in a live jazz music playing on piano or guitar or the like.

When the timing type is “Type 0” as a result of the determination in step S303 of FIG. 3, the CPU 101 selects one of the note timing tables exclusive for “Type 0” stored in the ROM 102 and stores the selected note timing table into the RAM 103 in step S305.

FIG. 5E illustrates an example of the data structure of a note timing table prepared for the timing type “Type 0.” The basic data structure is the same as the examples of the tables of the “Types 1 to 3” illustrated in FIG. 5A or 5C. Note that, however, in the Gate row of “Type 0 note timing table” illustrated in FIG. 5E, a chord length=0 [tick] is set at every timing of the eight sound emission timings of one measure in half-beat units.

As described above, if the CPU 101 selects the “Type 0 note timing table” in FIG. 5E, for example, in step S303 −>step S305, a whole rest is used for the measure and the chord is not emitted resultantly as represented by the musical notation in FIG. 5F.

As described above, in this embodiment, the timing type “Type 0” is probabilistically selected for each measure, thereby enabling the automatic chord accompaniment where a chord is not emitted in the measure as a musical expression.

When the timing type is “Type C” as a result of the determination in step S303 of FIG. 3, the CPU 101 first searches for the chord positions set in the automatic chord accompaniment data, which is acquired from the ROM 102 in step S301, in step S306.

Then, in step S307, the CPU 101 generates a note timing table in the same format as in FIG. 5A or 5C or the like, according to the chord positions searched for in step

S306, and stores the note timing table in the RAM 103.

When the CPU 101 generates the note timing table for “Type C” in step S303 −>step S306 as described above, a changed chord is emitted every time the chord is changed by the automatic chord accompaniment data in the measure, as a result.

FIG. 6 is a flowchart illustrating a detailed example of anticipation chord acquisition processing in step S207 of FIG. 2. This processing generates an anticipation. The term “anticipation” means music playing in which a specified chord is played a half-beat ahead. Since the generation of the anticipation is ineffective in some cases depending on the tune of the music piece of the automatic chord accompaniment, the player is able to turn on or off a selector switch for the anticipation, which is not particularly illustrated, in the switch section 105 of FIG. 1. Alternatively, the antiquation may be set on or off at the factory when the automatic chord accompaniment is stored in the ROM 102.

In the flowchart illustrated in FIG. 6, the CPU 101 first proceeds to step S604 to generate the antiquation if all of the following determinations in steps S601, S602, and S603 are YES.

Step S601: Whether the anticipation processing is set on by the “player” settings or the factory settings Step S602: Whether the current note timing is on an upbeat Step S603: Whether there is any chord change (a chord different from the current chord) in the automatic chord accompaniment on the next beat

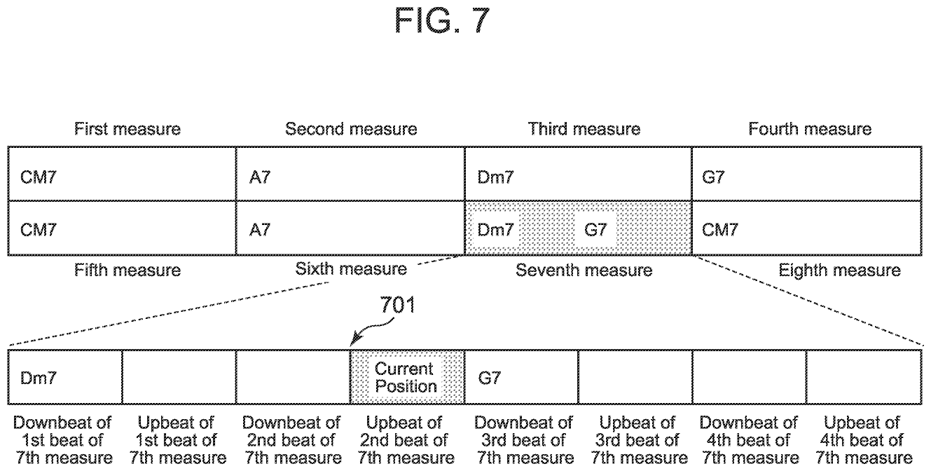

FIG. 7 is an explanatory diagram for the anticipation chord acquisition processing. For example, as illustrated in FIG. 7A, it is assumed that the following chords are given for the chord progression: CM7 (a downbeat of the first beat of the first measure), A7 (a downbeat of the first beat of the second measure), Dm7 (a downbeat of the first beat of the third measure), G7 (a downbeat of the first beat of the fourth measure), CM7 (a downbeat of the first beat of the fifth measure), A7 (a downbeat of the first beat of the sixth measure), Dm7 (a downbeat of the first beat of the seventh measure), G7 (a downbeat of the third beat of the seventh measure), and CM7 (a downbeat of the first beat of the eighth measure). Moreover, as illustrated in an enlarged view of the seventh measure in FIG. 7B, it is assumed that the current timing 701 is located at the head timing of the upbeat of the second beat of the seventh measure, where “current position” is written.

The chord G7 is specified at the head timing of the downbeat of the third beat of the seventh measure, which follows the upbeat of the second beat of the seventh measure. In this case, in the anticipation chord acquisition processing of step S207 in FIG. 2, an instruction is given to emit sounds for the chord G7 specified at the downbeat of the third beat of the seventh measure, which is the next beat, half a beat ahead at the timing of the upbeat of the second beat of the seventh measure, which is the current timing 701.

Specifically, if the anticipation processing is currently set on, then when the CPU 101 performs the anticipation chord acquisition processing of step S207 in FIG. 2 at the timing 701 in FIG. 7, all the determinations of the steps S601, S602, and S603 in FIG. 6 are YES. As described above in the description of the counter update processing in step S211 of FIG. 2, the CPU 101 determines whether the current timing is the head timing of the upbeat in step S602 of FIG. 6, by determining whether the intra-beat tick counter variable value stored in the RAM 103 is 64 [ticks], for example. Moreover, the CPU 101 determines whether a chord change is present on the next beat in step S603 of FIG. 6 by confirming the chord specifications of the current beat and the next beat stored in the RAM 103.

Unless any chord change is present on the next beat (the determination of step S603 is NO), the CPU 101 acquires the chord at the present time (step S604). When a chord change is present on the next beat (the determination of step S603 is YES), in other words, if the chord changes on the next beat, the CPU 101 acquires the chord on the next beat (step S605).

Finally, the CPU 101 stores the acquired chord into the RAM 103 as sound emission chord data for use in voicing processing described later (step S606).

As described above, when all the determinations in steps S601, S602, and S603 are YES, the CPU 101 performs the anticipation processing. In other words, the chord on the next beat is acquired as a chord to be emitted this time. When the sound emission timing is the upbeat of the fourth beat, the accompaniment data of the next measure is read into the RAM 103, and the chord of the first beat of the next measure is referenced to determine whether a chord change is present.

FIG. 8 is a flowchart illustrating a detailed example of voicing processing in step S208 of FIG. 2. In the voicing processing, the CPU 101 decides the voicing table data for the chord and key corresponding to the current note-on extracted from the automatic chord accompaniment data of the current measure stored in the RAM 103 and then stores the voicing table data in the note-on area of the RAM 103.

The CPU 101 first determines whether the sound emission chord data stored in the RAM 103 in step S606 of FIG. 6 is the same as the chord of the previous sound emission stored in the RAM 103 (step S801).

When the determination of step S801 is YES, the CPU 101 continues to use the last selected voicing table data and terminates the voicing processing of step S208 in FIG. 2 as illustrated in the flowchart in FIG. 8. As a result, the CPU 101 instructs the sound source LSI 508 to emit the music sounds of the note number corresponding to each voice of the voice group indicated by the voicing table data that is the same as the previous one stored in the RAM 103 in the note-on processing of step S209 of FIG. 2 described above.

When the determination of step S801 is NO, the CPU 101 performs the voicing processing described below.

First, the CPU 101 acquires the key of the music piece at the current note-on timing from the automatic chord accompaniment data read in the RAM 103 (step S803). The automatic chord accompaniment data is read into the RAM 103 in step S301 of FIG. 3 described above in the timing data generation processing in step S203 of FIG. 2. As for the chord, the sound emission chord data stored in the RAM 103 in step S606 of FIG. 6 is used in the following voicing processing. Since the key does not change throughout the music piece in many cases, the key may be previously read into the RAM 103 as key information separately in step S301 of FIG. 3, and the information may be used here, instead of reading the key for each measure. The CPU 101 stores the acquired chord information into the RAM 103 as the previous chord information to be determined in step S801 described above next time.

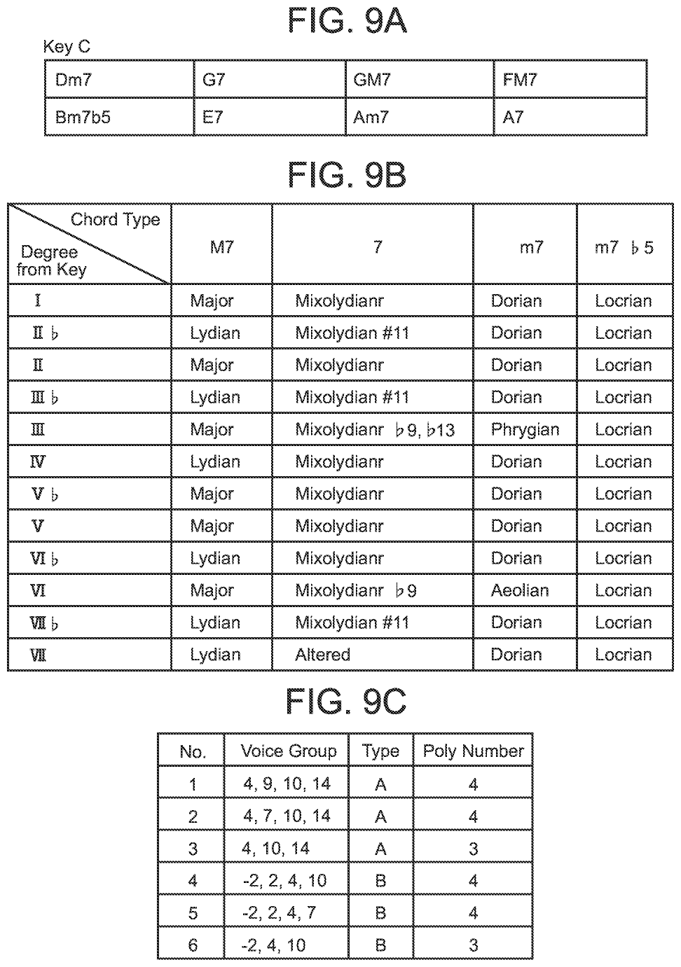

For example, it is assumed here that, as illustrated in FIG. 9A, key=C (represented by “Key C” in the figure), chord progression=Dm7, G7, CM7, FM7, Bm7b5, E7, Am7, and A7 (for example, one chord per measure) are sequentially specified according to the automatic chord accompaniment data read in the RAM 103. Consideration is then given to a case where the voicing processing in step S208 of FIG. 2 illustrated in the flowchart of FIG. 8 has been performed at an arbitrary note-on timing (chord emission timing) specified by the note timing data described above in the second measure illustrated in FIG. 9A, for example. In this case, the CPU 101 acquires the chord=G7 and the key=C in step S803, for example. Moreover, consideration is given to a case where the voicing processing in step S208 of FIG. 2 illustrated in the flowchart of FIG. 8 has been performed at an arbitrary note-on timing (chord emission timing) specified by the note timing data described above in the sixth measure illustrated in FIG. 9A, for example. In this case, the CPU 101 acquires the chord=E7 and the key=C in step S803, for example.

Subsequently, the CPU 101 performs the processing of deciding a scale by referring to the scale decision table stored in the ROM 102 (step S804). FIG. 9B illustrates an example of the data structure of the scale decision table. In the scale decision table, the name of the scale of the chord is registered at the registered position, which is the intersection of each row and each column of the table illustrated in FIG. 9B, according to the chord type (each column in the horizontal direction of the table illustrated in FIG. 9B) of the acquired chord and to the degree (each row in the vertical direction of the table illustrated in

FIG. 9B) from the pitch of the key to the pitch of the root note of the chord. As illustrated in FIG. 9B, the following scales are able to be registered: the Major scale, the Lydian scale, the Mixolydian scale, the Mixolydian #11 scale, the Mixolydian scale 69 scale, the Mixolydian scale 69613 scale, the Altered scale, the Dorian scale, the

Phrygian scale, the Aeolian scale, the Locrian scale, and so on. Other scales that can be used in various musical genres may be registered. Then, for example, consideration is given to a case where, in step S803, the CPU 101 acquires the chord=G7 and the key=C at an arbitrary note-on timing (chord emission timing) of the second measure during the chord progression as illustrated in FIG. 9A, which is the current note-on timing. In this case, the CPU 101 refers to the scale decision table illustrated in FIG. 9B, based on the degree=5 (“V” in FIG. 9B) from the key=C to the root note G of the chord G7 and based on the chord type=7. As a result, the CPU 101 decides the scale=“Mixolydian” from the intersection position between the row “V” and the column “7.” In addition, for example, consideration is given to a case where, in step S803, the CPU 101 acquires the chord=E7 and the key=C at an arbitrary note-on timing (chord emission timing) of the sixth measure during the chord progression as illustrated in FIG. 9A, which is the current note-on timing. In this case, the CPU 101 refers to the scale decision table illustrated in FIG. 9B, based on the degree=3 (“III” in FIG. 9B) from the key=C to the root note E of the chord E7 and based on the chord type=7. As a result, the CPU 101 decides the scale=“Mixolydianb9b13” from the intersection position between the row “III” and the column

Subsequently, the CPU 101 acquires a voicing table, which is prepared in advance and stored in the ROM 102 for each scale decided in step S804, from the ROM 102 (step S805). FIG. 9C illustrates an example of the data structure of the voicing table in the case where the scale is “Mixolydian.” For example, in the case of acquiring the chord=G7 and the key=C in step S803 and further deciding scale=“Mixolydian” in step S804 as descried above, the CPU 101 acquires the voicing table illustrated in FIG. 9C from the ROM 102.

In chord accompaniment, voicing of a chord is important. The term “voicing” means deciding which voices are stacked in an octave and how these voices are stacked in order to emit a single chord. In jazz or other musical genres, a so-called tension note is often used, where the tension note is nine, 11, or 13 degrees above the root note in semitone increments in chord accompaniment. The use of these voices enables tense and fully musical chord playing to be achieved. In chord playing, the important point is which scale is used, and the tension that can be used depends on the key and chord. Therefore, in this embodiment, the CPU 101 decides the playable “Mixolydian” scale, for example, on the basis of, for example, the chord=G7 and the key=C specified at the current note-on timing in steps S803 and S804 of FIG. 8.

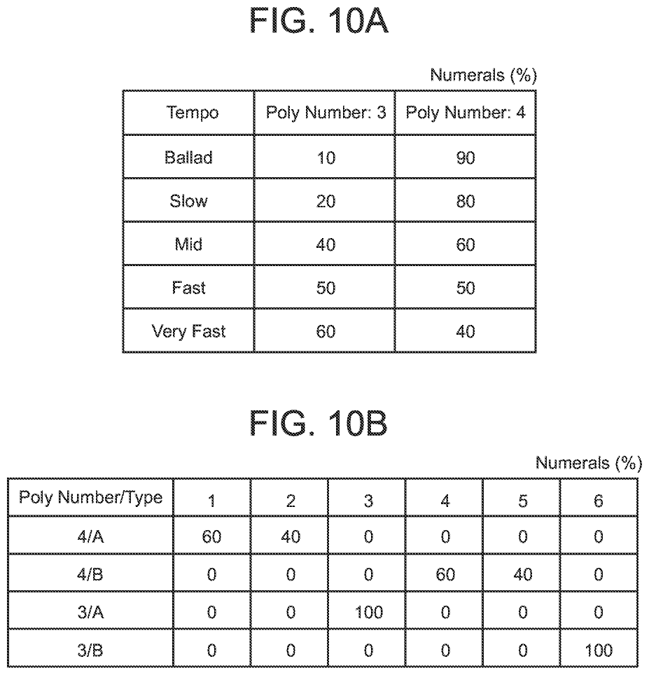

Furthermore, in this embodiment, in the case where, for example, the chord=G7 is emitted in the “Mixolydian” scale at the current note-on timing, even if it is the same “G7 Mixolydian,” one voicing (voicing pattern) can be probabilistically selected from multiple types (for example, six types in FIG. 9C) of voicing variations, and note-on processing is able to be performed for the chord=G7 with the voicing. For example, if the voicing table data of No. 1 is selected in the voicing table illustrated in FIG. 9C, there is used a voice group including four tones having the intervals of four semitones (major third: B), nine semitones (major sixth: E), 10 semitones (minor seventh: F), and 14 semitones (major ninth: A) in semitone increments relative to the root note G in the note-on of the chord=G7. Moreover, for example, if the voicing table data of No. 3 is selected, there is used a voice group including three tones having the intervals of four semitones (major third: B), 10 semitones (minor seventh: F), and 14 semitones (major ninth: A) in semitone increments relative to the root note G in the note-on of the chord=G7. Note that, in chord playing with tension such as jazz music playing, the root note is generally not emitted in many cases, and therefore the voice group in the voicing table does not include the root note (degree 1) in many cases. The elements used to decide a set of voicing table data from a voicing table relate to a voicing type, which is generally called A type or B type in a lot of musical genres including jazz, and the poly number, which indicates the number of notes to be emitted. A difference between A type and B type is whether the voicing has a wide range or a narrow range. A type is a voicing type in which the voicing includes a tension note and is formed by building up voices with, for example, 3rd, 5th, 7th, and 9th degrees relative to the root note. B type is a voicing type having a range narrower than the range of A type by lowering, for example, the 7th and 9th degrees by an octave from those of the A-type voicing. The voicing table illustrated in FIG. 9C indicates that the voicing table data of No. 1 and No. 2 are able to be selected in the case where the voicing type is A and the poly number is 4. Both of these two pieces of voicing table data are able to be selected in the case where the voicing type is A and the poly number is 4, but which one is selected in such a case is probabilistically decided by using the frequency table for voicing table data selection illustrated in FIG. 10B described later by the process in step S810 of FIG. 8. Moreover, the voicing table indicates that the voicing table data of No. 3 is able to be selected in the case where the voicing type is A and the poly number is 3. Since only the voicing table data of No. 3 is able to be selected in the case where the voicing type is A and the poly number is 3, the voicing table data of No. 3 is always selected in that case. Furthermore, the voicing table indicates that the voicing table data of No. 4 and No. 5 are able to be selected in the case where the voicing type is B and the poly number is 4. Both of these two pieces of voicing table data are able to be selected in the case where voicing type is B and the poly number is 4, but which one is selected in such a case is probabilistically decided by using the frequency table for voicing table data selection illustrated in FIG. 10B, which is described later, by the process of step S810 in

FIG. 8. In addition, the voicing table indicates that the voicing table data of No. 6 is able to be selected in the case where the voicing type is B and the poly number is 3. Since only the voicing table data of No. 6 is able to be selected in the case where the voicing type is B and the poly number is 3, the voicing table data of No. 6 is always selected in that case.

To implement the above voicing table data selection operation, the CPU 101 first decides the poly number probabilistically by referring to the frequency table for poly number selection that is prepared in advance and stored in the ROM 102 (step S806). FIG. 10A illustrates an example of the data structure of a frequency table for poly number selection. The “Ballad,” “Slow,” “Mid,” “Fast,” and “Very Fast” registered in the leftmost column of the frequency table for poly number selection illustrated in FIG. 10A indicate tempo ranges of the automatic chord accompaniment data, respectively, in the same manner as those of the frequency table for timing type selection in FIG. 4A.

In step S806 of FIG. 8, the CPU 101 performs the following control processing by using the frequency table for poly number selection illustrated in FIG. 10A, which is stored in the ROM 102. First, in the case where, for example, a tempo range “Ballad” is set in the automatic chord accompaniment data read from the ROM 102 in step S301 of FIG. 3 in the timing data generation processing in step S203 of FIG. 2, then the CPU 101 refers to the data in the row where “Ballad” is registered in the leftmost item in the frequency table for poly number selection illustrated in FIG. 10A. In this row, there are set frequency values [%], each of which indicates that the poly number 3 or 4 is selected with a probability of 10% or 90%. In response thereto, the CPU 101 generates an arbitrary random number value with a value range of 1 to 100, for example, in the same way as in step S302 of FIG. 3 described above. Then, the CPU 101 selects “poly number 3” if, for example, the generated random number value is in the random number range of 1 to 10 (corresponding to the frequency value 10% of “poly number 3”). Alternatively, the CPU 101 selects “poly number 4” if, for example, the generated random number value is in the random number range of 11 to 100 (corresponding to the frequency value 90% of “poly number 4”). In this way, the CPU 101 is able to select the poly numbers of “poly number 3” and “poly number 4” with the probabilities of 10% and 90% set in the “Ballad” row of the frequency table for poly number selection, respectively. Also in the case where, for example, the tempo range “Slow,” “Mid,” “Fast,” or “Very Fast” is set in the automatic chord accompaniment data read from the ROM 102 in step S301 of FIG. 3, the CPU 101 refers to, for example, each frequency value in any one of the rows in which “Slow,” “Mid,” “Fast,” or “Very Fast” is registered in the leftmost item in the frequency table for poly number selection having the configuration illustrated in FIG. 10A. Subsequently, the CPU 101 sets each random number range within the range of 1 to 100 according to the frequency value [%] set for each poly number of “poly number 3” or “poly number 4” in the row. Then, the CPU 101 generates a random number value in the range of 1 to 100 and then selects the “poly number 3” or “poly number 4” depending on which of the above random number ranges the generated random number value falls into. In this way, the CPU 101 is able to select each of the poly numbers, “poly number 3” and “poly number 4” with the probability corresponding to the frequency value set in each tempo range row of the frequency table for poly number selection.

The content of the poly number for implementing a natural music playing varies depending on the tempo and tune of the music piece. Therefore, in this embodiment, the CPU 101 refers to the frequency table for poly number selection having the data structure illustrated in FIG. 10A, by which the degree of occurrence of the poly number is decided, for each tune of “Ballad,” “Slow,” “Mid,” “Fast,” “Very Fast,” or the like. The CPU 101, which performs the above process of step S806, operates as a sound number selection unit.

After deciding the poly number in step S806, the CPU 101 determines whether the note-on target chord should be of the voicing type A or B described above. Specifically, the CPU 101 determines whether the pitch of the root note of the note-on target chord is F# or higher (step S807). When the determination of step S807 is NO, the CPU 101 selects A type as the voicing type of the current chord (step S808). When the determination of step S807 is YES, the CPU 101 selects B type as the voicing type of the current chord (step S809). The determination of step S807 is performed to divide one octave at its halfway point so that respective chords stay within a certain range and keep the range from jumping too much by a chord transition. The CPU 101, which performs steps S807 to S809, operates as a voicing type decision unit.

Finally, the CPU 101 uses the frequency table for voicing table data selection that is prepared and stored in the ROM 102 so as to correspond to the voicing table illustrated in FIG. 9C, which is acquired from the ROM 102 in step S805 described above, to probabilistically extract the optimal voicing table data from the voicing table illustrated in FIG. 9C on the basis of a combination of the poly number (3 or 4) and the voicing type (A or B) decided by the processes of steps S806 to S809 and then to store the voicing table data into the RAM 103 (step S810). The CPU 101, which performs step S810, operates as a voicing pattern selection unit.

FIG. 10B illustrates an example of the data structure of a frequency table for voicing table data selection. Each of the “4/A,” “4/B,” “3/A,” and “3/B” registered in the leftmost column of the frequency table for voicing table data selection illustrated in FIG. 10B is a combination of the poly number (3 or 4) and the voicing type (A type or B type) decided in steps S806 to S809.

In step S810 of FIG. 8, the CPU 101 performs the following control processing. First, in the case where the “poly number/voicing type” decided in steps S806 to S809 is “4/A,” the CPU 101 refers to data in the row in which “4/A” is registered in the leftmost item in the frequency table for voicing table data selection illustrated in FIG. 10B.

There is set a frequency value [%] that indicates that the voicing table data of No. 1 or 2 is selected with a probability of 60% or 40%. Since the voicing table data of other numbers each have 0% set as a frequency value, the voicing table data of these numbers cannot be selected for the combination of “4/A.” On the other hand, the CPU 101 generates an arbitrary random number value with a value range of, for example, 1 to 100 in the same way as in the case of step S806 described above. Then, the CPU 101 selects the voicing table data of No. 1 if, for example, the generated random number value is in the random number range of 1 to 60 (corresponding to the frequency value 60% of No. 1). Alternatively, for example, if the generated random number value is in the random number range of 61 to 100 (corresponding to the frequency value 40% of No. 1), the CPU 101 selects the voicing table data of No. 1. In this manner, the CPU 101 selects the voicing table data of No. 1 and No. 2 with the probabilities of 60% and 40%, respectively, set in the “4/A” row of the frequency table for voicing table data selection.

Also in the case where the “poly number/voicing type” decided in steps S806 to S809 is “4/B,” “3/A,” or “3/B,” in the same way as in the above case where “4/A” is set, the CPU 101 refers to each frequency value in any row where “4/B,” “3/A,” or “3/B” is registered in the leftmost item in the frequency table for voicing table data selection having the structure illustrated in FIG. 10B, for example. Subsequently, the CPU 101 sets each random number range within the range of 1 to 100 according to the frequency value [%] set for each voicing table data of No. 1 to No. 6 in the row. Then, the CPU 101 generates a random number value in the range of 1 to 100, and selects any one of the voicing table data of No. 1 to No. 6 according to which of the above random number ranges the generated random number value falls in. In this way, the CPU 101 selects each of the voicing table data of No. 1 to No. 6 in the voicing table illustrated in FIG. 9C with the probability corresponding to each frequency value set in each “poly number/voicing type” row of the frequency table for voicing table data selection in FIG. 10B. In step S810, the CPU 101 stores the voicing table data, which is extracted from the voicing table in FIG. 9C as described above, into the RAM 103.

After the process of step S810, the CPU 101 terminates the voicing processing of step S208 in FIG. 2, which is illustrated in the flowchart of FIG. 8.

In this embodiment, the voicing processing described above enables an appropriate selection of a scale in accordance with music theory in corresponding ways to the note-on target chord and key in an automatic chord accompaniment, and enables provision of candidates for voicing table data of a plurality of variations corresponding to the scale as voicing tables. Subsequently, in this embodiment, one of the candidates for the voicing table data of the plurality of variations in the above is able to be probabilistically extracted on the basis of the combination of the poly number and the voicing type probabilistically decided. Then, in this embodiment, the note-on processing is able to be performed for the chord in the automatic chord accompaniment by using the voice group given as the voicing table data extracted as described above. This enables various variations of automatic chord accompaniment in accordance with music theory.

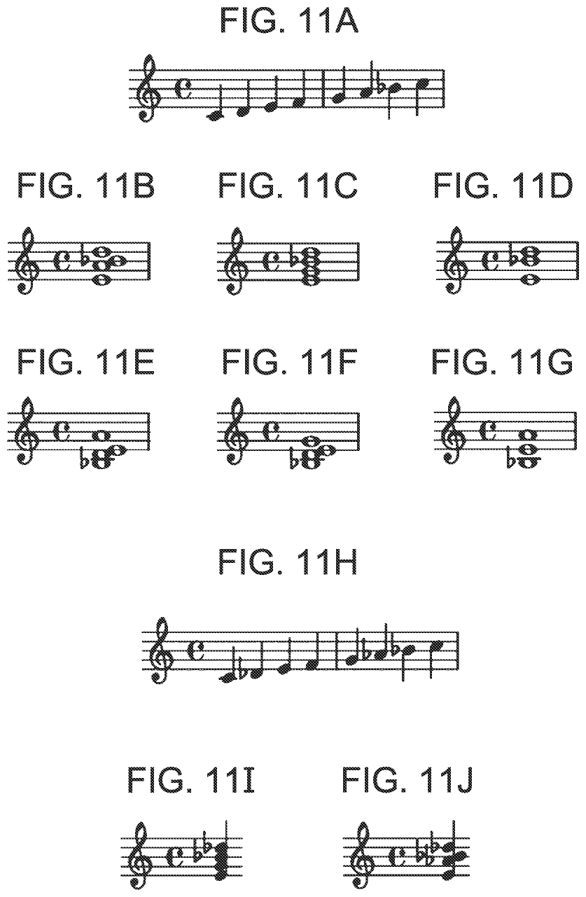

FIG. 11A illustrates a musical notation of C7 (Mixolydian scale), and FIGS. 11B, 11C, 11D, 11E, 11F, and 11G are musical notations illustrating examples of voicing variations in C7 (Mixolydian scale). FIG. 11B illustrates a musical notation of an example of a C7 chord with the voicing type A and the poly number 4 including the 9th and 13th tension notes. FIG. 11C illustrates a musical notation of an example of a C7 chord with the voicing type

A and the poly number 4 including the 9th tension note. FIG. 11D illustrates a musical notation of an example of a C7 chord with the voicing type A and the poly number 3 including the 9th tension note. FIG. 11E illustrates a musical notation of an example of a C7 chord with the voicing type B and the poly number 4 including the 9th and 13th tension notes. FIG. 11F illustrates a musical notation of an example of a C7 chord with the voicing type B and the poly number 4 including the 9th tension note. FIG. 11G illustrates a musical notation of an example of a C7 chord with the voicing type B and the poly number 3 including the 13th tension note.

FIG. 11H illustrates a musical notation of the “C7 Mixolydian b9b13” scale used as a minor scale, and FIGS. 10I and 10J illustrate musical notations illustrating examples of voicing variations in the “C7 Mixolydian 69613” scale. FIG. 11I illustrates a musical notation of an example of a C7 chord with the voicing type A and the poly number 4 including the 69th tension note. FIG. 11J illustrates a musical notation of an example of a C7 chord with the voicing type A and the poly number 4 including the b9th and b13th tension notes.

As illustrated in FIGS. 11A to 11J, in this embodiment, automatic chord accompaniment is able to be performed with chords having a variety of voicings.

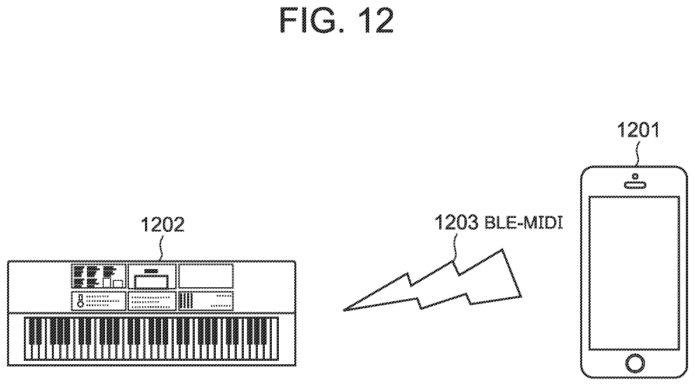

The embodiment described above is an embodiment in which the automatic music playing device according to the present disclosure is built in the electronic keyboard instrument 100 illustrated in FIG. 1. On the other hand, the automatic music playing device and the electronic musical instrument may be separate devices. Specifically, as illustrated in FIG. 12, for example, the automatic music playing device may be installed as an automatic music playing application in a smartphone or a tablet terminal (hereinafter, referred to as “smartphone or the like 1201”), for example, and the electronic musical instrument may be, for example, an electronic keyboard instrument 1202 without the automatic chord accompaniment function. In this case, the smartphone or the like 1201 and the electronic keyboard instrument 1202 wirelessly communicate with each other on the basis of, for example, a standard called “MIDI over Bluetooth Low Energy” (hereinafter, referred to as “BLE-MIDI”: Bluetooth is a registered trademark). BLE-MIDI is a wireless communication standard between musical instruments that enables communication using the musical instrument digital interface (MIDI) standard for communication between musical instruments over the Bluetooth Low Energy wireless standard. The electronic keyboard instrument 1202 is able to be connected to a smartphone or the like 1201 using the Bluetooth Low Energy standard. In this state, the automatic chord accompaniment data based on the automatic chord accompaniment function described in FIGS. 2 to 11 is transmitted, as MIDI data, to the electronic keyboard instrument 1202 by the automatic music playing application running on the smartphone or the like 1201 via the BLE-MIDI standard communication channel. The electronic keyboard instrument 1202 performs the automatic chord accompaniment described in FIGS. 2 to 11 on the basis of the automatic chord accompaniment MIDI data received in the BLE-MIDI standard.

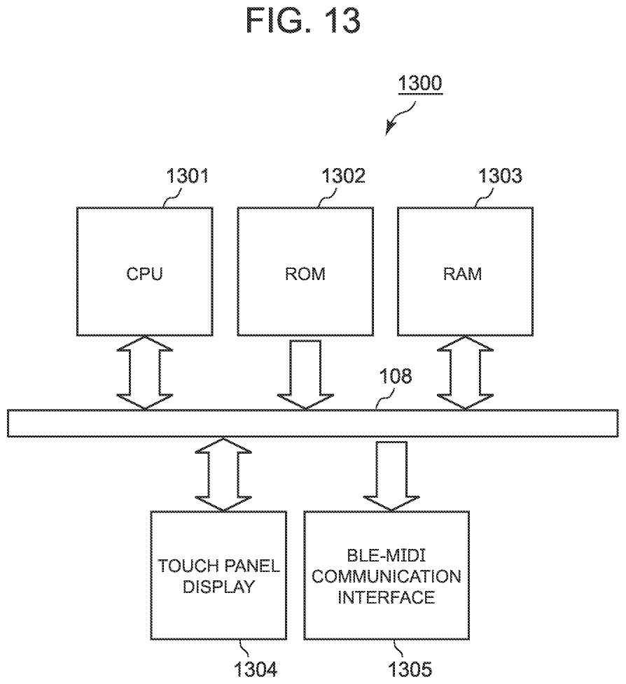

FIG. 13 illustrates an example of the hardware configuration of an automatic music playing device 1201 in another embodiment, in which the automatic music playing device and the electronic musical instrument having the connection form illustrated in FIG. 12 operate separately. In FIG. 13, a CPU 1301, a ROM 1302, a RAM 1303, and a touch panel display 1304 have the same functions as the CPU 101, the ROM 102, and the RAM 103 in FIG. 1. The CPU 1301 executes the program of the automatic music playing application downloaded and installed in the RAM 1303, thereby implementing the same function as the automatic chord accompaniment function described in FIGS. 2 to 11, which is achieved by the CPU 101 executing the control program. In this case, the function equivalent to the switch section 105 in FIG. 1 is provided by the touch panel display 1304. Then, the automatic music playing application converts the control data for automatic chord accompaniment to automatic chord accompaniment MIDI data, and passes the MIDI data to the BLE-MIDI communication interface 1305.

The BLE-MIDI communication interface 1305 transmits the automatic chord accompaniment MIDI data generated by the automatic music playing application to the electronic keyboard instrument 1202 according to the BLE-MIDI standard. As a result, the electronic keyboard instrument 1202 performs the same automatic chord accompaniment as in the case of the electronic keyboard instrument 100 illustrated in FIG. 1. Instead of the BLE-MIDI communication interface 1305, a MIDI communication interface that connects to the electronic keyboard instrument 1202 with a wired MIDI cable may be used.

As described above, this embodiment enables an automatic chord accompaniment with a composition of an emitted chord (voicing) including a tension note, which is a characteristic of jazz and the like, and an automatic chord accompaniment with the number of sounds and range that are more natural, which have been problems of the conventional techniques, and enables provision of an automatic accompaniment of chord parts as if played by a pianist of jazz or the like. Particularly, this embodiment enables provision of a more natural chord accompaniment by implementing a more natural range to emit a chord in a music playing position including a tension note requiring less range shift at the time of a chord change and, in the absence of a chord change, to emit a chord naturally without changing voicing unnecessarily, and by adjusting the number of sounds to be simultaneously emitted (or not emitted, as the case may be) by an algorithm according to the tune and the unique music piece structure of jazz or the like, such as theme and solos. This enables a player to experience the music playing as if the player were participating in a jam session. Moreover, the present invention is also able to be used as a part of training, for example, for those who want to play jazz but hesitate to participate in a jam session because they do not have the courage to do so. In addition, with the automatic chord accompaniment having the characteristics of jazz and the like, the present invention is also able to be used as part of education, such as the research and practice of phrasing when playing solos (ad-libs) in jazz or the like. In this way, the automatic music playing device according to this embodiment enables a player to achieve the natural automatic chord accompaniment capable of expressing the timings and voicings of live music playing of a musical instrument.

The present invention is not limited to the above-described embodiments, and can be modified in various ways without departing from the gist of the invention at the implementation stage. In addition, the functions performed in the above-described embodiments may be combined as appropriate for implementation to the extent possible. The above-described embodiments include various steps, and various inventions can be extracted by appropriate combinations of the disclosed plurality of constituent requirements. For example, even if some of the constituent requirements are deleted from all the constituent requirements described in the embodiments, the structure made up of the elements resulting from the deletion of the constituent requirements may be extracted as an invention, if the advantageous effect can be obtained.

What is claimed is:

1. An automatic music playing control device, comprising at least one processor,
wherein the at least one processor:
selects a voicing pattern corresponding to a combination of the probabilistically-selected number of sounds to be emitted and a decided voicing type corresponding to a range from among a plurality of voicing patterns based on a scale decided according to the tune and chords of a music piece; and
instructs a sound source to emit a chord voiced based on the selected voicing pattern.

2. The automatic music playing control device according to claim 1,
wherein, in the case where there is a plurality of voicing patterns corresponding to the combination, the at least one processor probabilistically selects any one of the plurality of voicing patterns.

3. The automatic music playing control device according to claim 1,
wherein the at least one processor decides the voicing type based on the pitch of a root of a chord to be emitted.

4. The automatic music playing control device according to claim 1,
wherein the at least one processor instructs the sound source to emit the chord by communication.

5. An electronic musical instrument comprising:
the automatic music playing control device according to claim 1; and
the sound source,
wherein the sound source performs an automatic chord accompaniment based on the instruction of the chord emission.

6. A method of playing an automatic music playing device, comprising the steps of:
selecting a voicing pattern corresponding to a combination of the probabilistically-selected number of sounds to be emitted and a decided voicing type corresponding to a range from among a plurality of voicing patterns based on a scale decided according to the tune and chords of a music piece; and
instructing a sound source to emit a chord voiced based on the selected voicing pattern.

7. The method of playing the automatic music playing device according to claim 6,
wherein, in the case where there is a plurality of voicing patterns corresponding to the combination, any one of the plurality of voicing patterns is probabilistically selected.

8. The method of playing the automatic music playing device according to claim 6,
wherein the voicing type is decided based on the pitch of a root of a chord to be emitted.

9. The method of playing the automatic music playing device according to claim 6,
wherein the sound source is instructed to emit the chord by communication.

10. A non-transitory computer-readable recording medium storing a program of system, wherein the program is configured to allow a computer in an automatic music playing control device:
to select a voicing pattern corresponding to a combination of the probabilistically-selected number of sounds to be emitted and a decided voicing type corresponding to a range from among a plurality of voicing patterns based on a scale decided according to the tune and chords of a music piece; and
to instruct a sound source to emit a chord voiced based on the selected voicing pattern.

11. The non-transitory computer-readable recording medium according to claim 10,
wherein, in the case where there is a plurality of voicing patterns corresponding to the combination, any one of the plurality of voicing patterns is probabilistically selected.

12. The non-transitory computer-readable recording medium according to claim 10,
wherein the voicing type is decided based on the pitch of a root of a chord to be emitted.

13. The non-transitory computer-readable recording medium according to claim 10,
wherein the sound source is instructed to emit the chord by communication.
